(19) United States
(12) Patent Application Publication
(10) Pub. No.: US 2007/0125754 A1
(43) Pub. Date: Jun. 7, 2007

(54) Multipurpose track and radius plate burner system

(76) Inventor: John Nash, Magnolia, TX (US)

Correspondence Address: ARNOLD & FERRERA, L.L.P., 2401 FOUNTAIN VIEW DRIVE, SUITE 630, HOUSTON, TX, 77057, US

(21) Appl. No.: 11/636,236

(22) Filed: Dec. 7, 2006

Related U.S. Application Data
(60) Provisional application No. 60/748,039, filed on Dec. 7, 2005.
(60) Provisional application No. 60/786,176, filed on Mar. 27, 2006.

(51) Int. Cl. B23K 9/00

(52) U.S. Cl. 219/121.48

(57) ABSTRACT

A multipurpose plate burner system is presented where a collection of components may be selected in combination to configure the system to achieve one of a selection of purposes. A combination selected from supports, pivots, pivot arms, trammel points, and wheels support a shaft over a workpiece. The cutting nozzle of a torch is supported by one of a selection of torch nozzle receptacles, providing for a range of perpendicular or angled cutting edges. The shaft supports the selected torch nozzle receptacle. Additional components may be optionally selected, such as a saddle support fitted on the shaft for supporting the torch tool and additional torch leveling supports. Depending on the combination of components selected, the plate burner system may be configured to cut circles with or without beveling, cut in obstructed locations, such as corners, cut along track lines, or perform protractor and other marking functions.

### STATEMENT OF RELATED CASES

This application claims the benefit of U.S. Provisional Application No. 60/748,039, filed Dec. 7, 2005. This application claims the benefit of U.S. Provisional Application No. 60/786,176, filed Mar. 27, 2006.

### FIELD OF THE INVENTION

The present invention relates generally to methods and means by which cuts, including approximately circular cuts, can be made in a vessel such as a plate metal or a metal sheet, and in a specific though non-limiting embodiment, to a plate burner system having improved performance characteristics relative to the circle burners presently known in the prior art.

### BACKGROUND

Previously, circle burners have been limited in that there are well-understood, practical limits to the sizes and shapes of the cuts produced by the devices. For example, most known hand-tool type circle burners, which currently sell for around one hundred dollars, create only straight cuts of either nine inches or fifteen inches, and lack the capacity to bevel the boundary surface of the plate being modified. Moreover, the smallest diameter burn is only around two inches, and the device is fitted with a number of ball bearings in the tip head, which, when heated, tend to become fouled and impair the functionality of the device.

While commercial units are available to create beveled cuts, they are very large and bulky, and are also very expensive as compared to the hand tool variety. For example, a known circle burner capable of creating beveled cuts exists in which the apparatus is several feet tall and weighs between sixty-five pounds and one hundred pounds. The device currently sells for around two thousand dollars.

Accordingly, Applicant has invented a new and non-obvious hand tool that incorporates some of the beneficial features of the larger, stand-alone units, in a manner in which welders and other operators can quickly, easily and accurately cut plate steel, plate metal, metal sheet and the like, so that the resulting port is smooth around the edges, very nearly uniformly circular, and beveled using either an inside or outside cutting technique.

The invention at its core comprises an adjustable pivoting member and a cutting tip. In a presently preferred embodiment, however, the system includes both an adjustable torch stabilizer and an adjustable leveling member, so that the welder's torch is held steady, and the entire device is securely and reliably stabilized while cuts are being burned.

### SUMMARY OF THE INVENTION

According to one example of the invention, there is provided a multipurpose plate burner system comprising: a shaft, whereby a beam is formed; at least one sleeve movably attached to the shaft, the sleeve having a receiving channel disposed offset from the shaft; an object disposed in the receiving channel, whereby the object is operable to position a contact location with a workpiece. The system further comprises: a torch head receptacle attached to the shaft; wherein an object disposed in the receiving channel is selected from the group comprising: a pivot, a pivot arm having an offset pivot point, a leveling wheel, a roller bearing leveler, a trammel point, a soapstone holder, a torch nozzle holder, a table support, a torch saddle, and a flat bottomed pin. Further, the torch head receptacle may be a torch-nozzle receiving orifice integrated on an end of the shaft, or may be a torch nozzle holder affixed to a sleeve movably attached to the shaft. The torch head receptacle is operable to be positioned a fixed distance from the workpiece.

In another example, the shaft is comprised of one or more beam sections further comprising means for fitting said beam sections together.

In another example, at least one sleeve comprises: a first channel for receiving the beam of the shaft; and a second channel disposed offset from the first channel for receiving at least one object. In another example, at least one sleeve comprises a first locking means for affixing the sleeve to a position on said shaft. In another example, at least one sleeve comprises a second locking means for affixing at least one object to the sleeve.

In another example, the second channel of at least one sleeve comprises a substantially circular opening, whereby an object inserted there through may freely rotate therein. In another example, the second channel of at least one sleeve is disposed substantially perpendicular to the first channel.

In another example, at least one sleeve further comprises: a third channel, for receiving at least one object, the third channel disposed offset from the first channel and opposite the second channel, the third channel having an axial orientation similar to the axial orientation of the second channel; and a third locking means for affixing an object to the sleeve. In a further example, the axial orientation of the second channel and the axial orientation of the third channel are approximately fifty-five degrees relative to the axial direction of the first channel.

In another example, the torch nozzle holder comprises: a first attachment arm, having a first end; a torch head arm, having a first end, disposed adjacent and parallel to the first attachment arm, the first end of the first attachment arm connected to the first end of the torch head arm; a second attachment arm, having a first end, disposed adjacent and parallel to the torch head arm, the first end of the torch head arm connected to the first end of the second attachment arm; and a torch head receptacle disposed on a second end of the torch head arm, the torch head receptacle having a torch receiving orifice positioned perpendicular to the length of the torch head arm. The first attachment arm and the torch head arm and the second attachment arm are coplanar with respect to the perpendicularly positioned torch-receiving orifice. Further, the length of the first attachment arm is less than the length of the second attachment arm.

In another set of examples of the present invention, there is provided a multipurpose plate burner system comprising: a means for positioning a burning apparatus over a workpiece; a means for remotely guiding the burning apparatus; a first means for pivoting the positioning means about a first axis of rotation; a second means for pivoting the positioning means about a second axis of rotation; and a means for stabilizing the burning apparatus over the workpiece.

In another example, the means for remotely guiding comprises a shaft. In a further example, the shaft is comprised of one or more beam-sections further comprising means for fitting the beam sections together

In another example, the means for positioning comprises at least one sleeve movably attached to the remote guiding means, the sleeve having a receiving channel disposed offset from the remote guiding means; and at least one object disposed in the receiving channel, whereby the object is operable to position a location of contact with the workpiece.

In another example, the first means for pivoting comprises: one sleeve wherein the receiving channel comprises a substantially circular opening, whereby an object inserted there through may freely rotate therein. The inserted object may be a pivot, or a pivot arm.

In another example, the second means for pivoting comprises: a pivot arm disposed in the receiving channel of one sleeve; and a pivot attached to the pivot arm. In further example, the second means for pivoting comprises: a pivot arm; and a pivot disposed on the pivot arm, the pivot arm disposed in the first means for pivoting.

In another example, the means for stabilizing the burning apparatus comprises at least one sleeve movably attached to the remote guiding means, the sleeve having a receiving channel disposed offset from the remote guiding means; and at least one object disposed in the receiving channel, whereby the object is operable to position a location of contact with the workpiece. In a further example, the means for stabilizing the burning apparatus comprises at least one sleeve movably attached to the remote guiding means, the sleeve further comprising a location of contact with the burning apparatus.

According to one example of the invention, there is provided a multipurpose plate burner system comprising: a shaft for deploying a burning apparatus over a workpiece; a support movably attached to the shaft, the support providing a selected distance between the shaft and the workpiece; and a torch head receptacle attached to the shaft, the torch head receptacle providing a selected distance between the burning apparatus and the workpiece.

In a further example, the support may be a fixed support. The support may be a pivotal support. The support may be a multiple pivotal support.

### BRIEF DESCRIPTION OF THE DRAWINGS

FIG. 1A shows a schematic side view of an example of the present invention, showing a configuration for ninety-degree circle burning.

FIG. 1B shows a schematic side view of an example of the present invention, showing a configuration for beveled circle burning.

FIG. 1C shows a schematic side view of an example of the present invention, showing a configuration for circle burning in the presence of a corner or obstacles.

FIG. 2 shows a detailed perspective view of the shaft 1 of the present invention.

FIG. 3A shows a detailed perspective view of a locking sleeve 2 of the present invention.

FIG. 3B shows a detailed perspective view of a pivot arm sleeve 8 of the present invention.

FIG. 3C shows a detailed perspective view of a torch saddle 3 of the present invention.

FIG. 3D shows a detailed perspective view of an angled torch head sleeve 5 of the present invention.

FIG. 4A shows a detailed perspective view of a pivot 811 of the present invention.

FIG. 4B shows a detailed perspective view of a torch nozzle holder 15 of the present invention.

FIG. 4C shows a detailed perspective view of a soapstone holder 16 of the present invention.

FIG. 5A shows a detailed perspective view of an example of the present invention, showing a configuration for track burning at an angle ninety-degrees (unbeveled) to the cutting surface of the workpiece.

FIG. 5B shows a detailed perspective view of an example of the present invention, showing a configuration for track burning at an angle beveled to the cutting surface of the workpiece.

### DETAILED DESCRIPTION OF THE INVENTION

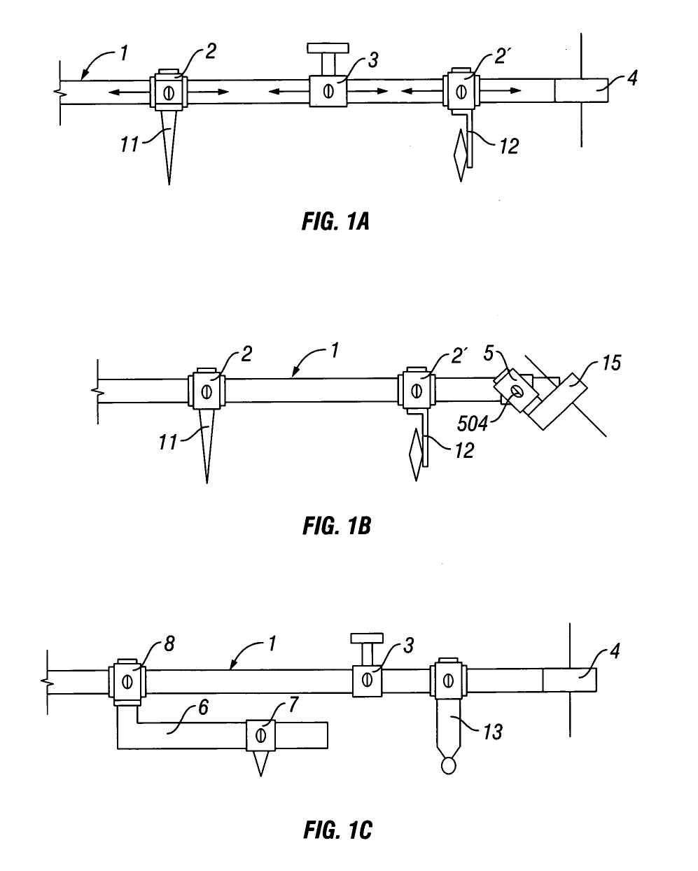

Various aspects of the invention, including alternative embodiments and the various functionalities associated therewith, are disclosed with particularity in the attached drawings, FIGS. 1 through 5. Applicant submits that those of ordinary skill in the art will recognize and be able to appreciate the advantages of the apparatus, which at present are known to include the capacity to burn cuts from zero to six feet or more in diameter, and to burn both interior and exterior diameters with either a straight cut, or an inside or outside bevel. Further advantages of the apparatus include the ability to reach under obstacles or into corners and make burns where a drill will not fit. Furthermore, the apparatus includes the ability to make a straight burn or bevel of lengths up to six feet. Unlike the prior art, the device does not require use of ball bearings, which may fail or otherwise impede functionality; has a torch stabilizer to ensure smooth, even cuts; and can be fitted to retroactively equip all presently known, standard-sized torches. An original torch system equipped with the circle burner disclosed herein is also presented.

As an example of the present invention, a multipurpose radius plate burner system is presented where a collection of components may be selected in combination to configure the system to achieve one of a selection of purposes. As illustrated in FIG. 1A, the system may be configured as a circle burner, typically by selecting an adjustable pivot 11 with locking sleeve 2, a torch saddle 3, a leveling wheel 12 with locking sleeve 2′, and torch head receptacle 4, all mounted on shaft 1. Shaft 1 is composed of a metal rod, typically square or octagonal in diameter. A torch device is placed over shaft 1, resting upon torch saddle 3 and torch head receptacle 4. The cutting nozzle of the torch device fits into torch head receptacle 4. In this configuration, as illustrated, the torch burns or cuts a hole whose edge is ninety-degrees or perpendicular to the cutting surface of the workpiece. As illustrated in FIG. 1B, the system may be configured as an inside or outside diameter (I.D./O.D.) bevel burner, typically by selecting adjustable pivot 11 with locking sleeve 2, leveling wheel 12 with locking sleeve 2′, and a right-hand-left-hand (R.H./L.H.) angled torch head sleeve 5, all mounted on shaft 1. A torch nozzle holder 15 is attached to angled torch head sleeve 5 and held in place using set screw 504. As illustrated in FIG. 1C, the system may be configured as a corner burner, typically by selecting torch saddle 3, torch head receptacle 4, a pivot arm pivot 7, pivot arm 6 with pivot arm sleeve 8, a ball bearing leveler 13, all mounted on shaft 1.

In the corner burner configuration, this example of the present invention allows variable setting of hole radius without the need to change the length of the shaft. Further, guidance of the tool may be accomplished from a more convenient location, as the longer shaft can be used to control cutting of smaller diameter holes, such as in corners or underneath obstacles. The use of a roller bearing for a leveler, along with the offset afforded by the pivot arm, in this configuration provides necessary freedom of movement to accomplish this remote hole cutting capability.

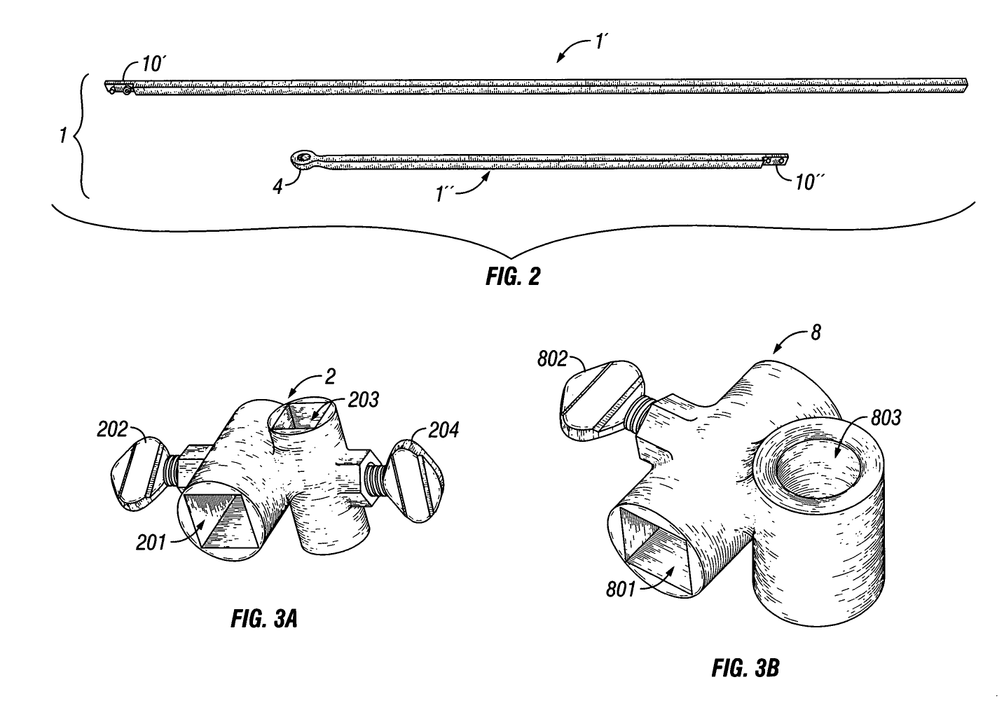

As illustrated in FIG. 2, shaft 1 may be comprised of one or more beam sections, 1′, 1″, which are fittably attached to one another such as to provide for an unobstructed beam along the length of shaft 1, and provided with means for fitting the beam sections together. For example, sections of shaft 1 may be fitted together end-to-end by internally placed matching screw threads along the axis of the shaft. In another example, sections of shaft 1 may be fitted together end-to-end by a mortice-styled configuration 10′, 10″ of the respective ends, allowing for placement of screw holes and screws perpendicular to the axis of the shaft. The beam sections of shaft 1 are typically approximately two feet in length, allowing for three sections to provide for a reach of approximately six feet. The torch end of shaft 1 is presented with a torch head receptacle 4, which is used to hold the nozzle of a typical cutting torch. In the present examples, torch head receptacle 4 is an integrated component of shaft 1, but may also be substituted with a removable torch nozzle holder, for example, the angled torch head sleeve 5 and torch nozzle holder 15 of FIG. 1B.

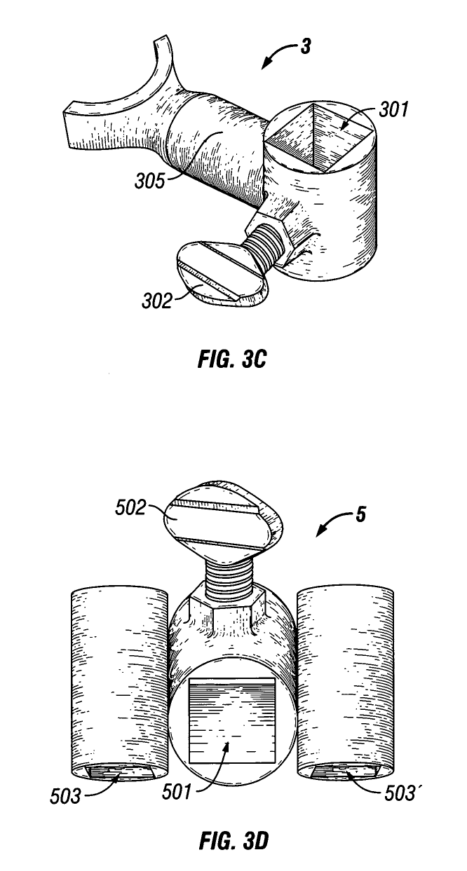

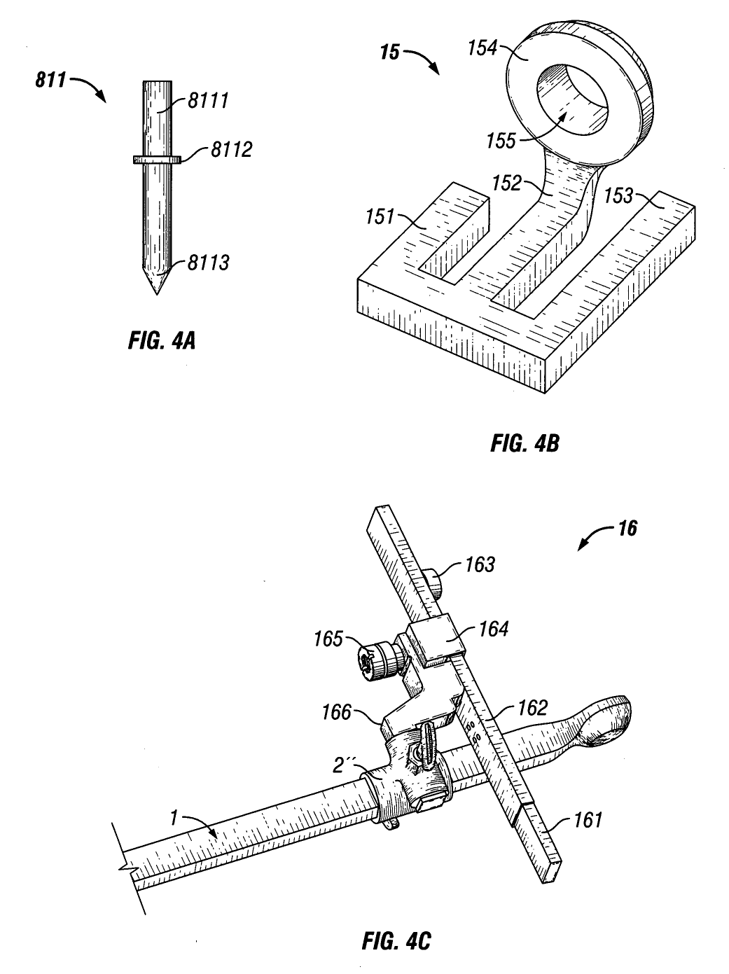

Sleeves of various configurations are illustrated in FIGS. 3A-3D. The basic locking sleeve 2, shown in FIG. 3A, comprises a channel 201 for receiving the beam of shaft 1; a locking means, such as set screw 202, is disposed into channel 201 for the purpose of locking the position of locking sleeve 2 on shaft 1; a receiving channel 203, of orientation typically perpendicular to channel 201, for holding one of a selection of objects. Optionally, a second locking means, such as set screw 204, is disposed into channel 203 for the purpose of affixing the selected object held in receiving channel 203. Objects that may be held by locking sleeve 2 include an adjustable pivot 11 (illustrated in FIG. 1A), leveling wheel 12 (illustrated in FIG. 1A), a trammel point (not illustrated, of the nature of pivot 11), and soapstone holder (illustrated in FIG. 4C). In practice, leveling wheel 12 is set to an elevation even with pivot 11 for burning or cutting a hole whose edge is ninety-degrees or perpendicular to the surface of the workpiece.

FIG. 3B illustrates a pivot arm sleeve 8, comprising a channel 801 for receiving the beam of shaft 1; a locking means, such as set screw 802, is disposed into channel 801 for the purpose of locking the position of pivot arm sleeve 8 on shaft 1; a receiving channel 803, of orientation-typically perpendicular to channel 801. A second locking means is not provided and receiving channel 803 is circular. Receiving channel 803 allows for free rotational movement of pivot arm sleeve 8, and attached shaft 1, about the object held in receiving channel 803. For example, a selected object, such as pivot arm 6 (FIG. 1C) or pivot 811 (illustrated in FIG. 4A), is constructed with a circular form and stop so as to fit into receiving channel 803, providing rotational mobility of shaft 1 about the selected object.

Torch saddle 3, shown in FIG. 3C, comprises a channel 301 for receiving the beam of shaft 1; a locking means, such as set screw 302, disposed into channel 301 for the purpose of locking the position of torch saddle 3 on shaft 1; and a saddle portion 305 integrated into the body of torch saddle 3, such that a typical torch assembly may rest upon torch saddle 3.

The angled torch head sleeve 5, shown in FIG. 3D, comprises a channel 501 for receiving the beam of shaft 1; a locking means, such as set screw 502, disposed into channel 501 for the purpose of locking the position of angled torch head sleeve 5 on shaft 1; a pair of receiving channels 503, 503′, of orientation typically angled to channel 501, for holding one of a selection of objects, such as torch nozzle holder 15. Set screws, for example, set screw 504 of FIG. 1B, affix torch nozzle holder 15 to angled torch head sleeve 5. The angle of orientation of receiving channels 503, 503′, for example, is fifty-five degrees with respect to channel 501 in order to provide for a thirty-five degree bevel. For bevels of other degree, the orientation of receiving channels 503, 503′ may be angled to channel 501 in the amount of the desired angle of the bevel subtracted from ninety degrees. The pair of receiving channels 503, 503′ allow angled torch head sleeve 5 to be attached to shaft 1 to provide either a right-hand or a left-hand orientation, providing for either an inside diameter bevel or an outside diameter bevel. This is accomplished simply by attaching angled torch head sleeve 5 in either a forward or reverse direction on shaft 1, and inserting torch nozzle holder 15 in either of receiving channels 503 or 503′.

Additional objects held by the sleeves, of various configurations, are illustrated in FIGS. 4A-4C. FIG. 4A illustrates a pivot 811, shaped and configured to be rotably received by pivot arm sleeve 8 (illustrated in FIGS. 1C and 3B). One end of pivot 811 typically comprises a circular shaft 8111 that is received by receiving channel 803 of pivot arm sleeve 8. A ridge along the length of pivot arm sleeve 8 creates stop 8112. The opposite end of pivot 811 comprises a point 8113 that is to be positioned on the workpiece. This creates a pivot point about which shaft 1 may be rotated. For wide burns, point 8113 may be tacked on the workpiece so as to provide additional adhesion to the workpiece.

FIG. 4B illustrates torch nozzle holder 15. Torch nozzle holder 15 comprises a pair of attachment arms 151, 153; a torch head arm 152; and a torch head receptacle 154. Torch head receptacle 154 is attached to one end of torch head arm 152 and is mounted such that the torch receiving orifice 155 of torch head receptacle 154 is perpendicular to torch head arm 152. Attachment arms 151 and 153 are positioned parallel and to either side of torch head arm 152. The opposite end of torch head arm 152 is connected to one end of each of attachment arms 151 and 153. Attachment arms 151, 153 and torch head arm 152 are all coplanar with respect to perpendicularly oriented torch head receptacle 154. Attachment arm 151 is shorter than attachment arm 153, allowing for proper positioning of torch receiving orifice 155 when torch nozzle holder 15 is inserted into torch head sleeve 5, such as for beveled circle burning or cutting. Attachment arm 153 is longer than attachment arm 151, allowing for proper positioning of torch receiving orifice 155 when torch nozzle holder 15 is inserted into sleeves designed for ninety-degree or track cutting.

In another example, the system may be configured as a protractor, typically by selecting an adjustable pivot with locking sleeve and a soapstone holder (or trammel point) with locking sleeve, all mounted on a shaft. FIG. 4C illustrates soapstone holder 16. Soapstone holder 16 is used to hold a piece of soapstone, which may be used to provide markings on the workpiece. Soapstone 161 is inserted into hollow shaft 162 and held in place by set screw 163. Hollow shaft 162 is slidable through soapstone sleeve 164 so as to allow for desired distance of the soapstone from shaft 1. Soapstone sleeve 164 has a set screw 165 that is perpendicular to the length of hollow shaft 162, enabling the position of soapstone sleeve 164 on hollow shaft 162 to be fixed. Pin 166 is affixed to soapstone sleeve 164 and parallel to the length of hollow shaft 162. Locking sleeve 2″ receives pin 166. Locking sleeve 2″ is attached to shaft 1 as previously described.

In another example, the system may be configured as a scribing device, typically by selecting an adjustable pivot with locking sleeve and a trammel point with locking sleeve, all mounted on a shaft.

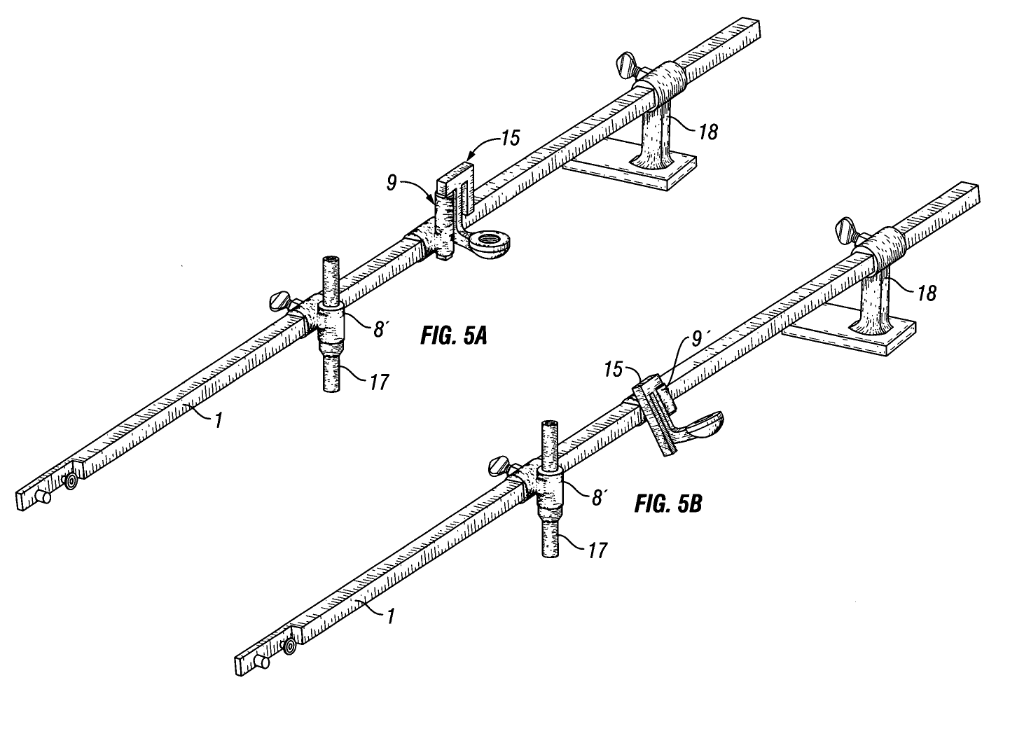

In another example, the system may be configured as a track burner, typically by selecting a slidable ninety-degree or angled/beveling torch sleeve, and a shaft stabilizer with locking sleeve, both mounted on a shaft. FIGS. 5A and 5B illustrate typical track burner configurations. In the track burner configurations, typically two shaft stabilizers orient the shaft along the line to be burned. By using a ninety degree or bevel torch head on a slidable sleeve, a line may be burned along the track of the shaft. A ninety-degree burn or a beveled burn may be accomplished, depending on the torch head/sleeve selection.

FIG. 5A illustrates an example of track burning or cutting a line whose edge is ninety-degrees or perpendicular to the cutting surface of the workpiece. Shaft 1 is supported on the workpiece by one or more, preferably two or more, stabilizers or supports. As illustrated in this example, one support is shown as support 17, which is a flat bottomed pin held in place by a pivot arm sleeve 8′. Pivot arm sleeve 8′ is fixed to shaft 1. The other support is shown as table support 18, which has one side of a flat surface disposed on the workpiece with an integrated sleeve for receiving shaft 1 disposed on the opposite side of the flat surface. Track sleeve 9 has a channel for receiving the beam of shaft 1 and a perpendicular receiving channel for receiving an attachment arm of torch nozzle holder 15. Track sleeve 9 is slidable along the length of the beam of shaft 1, between support 17 and table support 18.

FIG. 5B illustrates an example of track burning or cutting a line whose edge is beveled with respect to the cutting surface of the workpiece. Shaft 1 is supported above the workpiece by support 17 and table support 18. Track sleeve 9′ has a channel for receiving the beam of shaft 1 and an angled receiving channel for receiving an attachment arm of torch nozzle holder 15. Track sleeve 9 is slidable along the length of the beam of shaft 1, between support 17 and table support 18. The shorter attachment arm of torch nozzle holder 15 is used, as track sleeve 9′ is positioned lower relative to shaft 1, owing to the required change in position of the torch nozzle to effect the proper location and position for burning or cutting at the beveled angle.

From the foregoing illustrated examples, it can be seen that other system configurations may be assembled from the described components. In one further example, the system may be configured to accommodate lengths exceeding approximately one arm span, approximately six feet or greater, typically by selecting a round pivot with locking sleeve, the round pivot spot-tacked to the workpiece, leveling wheel with locking sleeve, and torch head sleeve, all mounted on a shaft. The system may also be configured as a mini-burner, typically by selecting an adjustable pivot with locking sleeve, leveling wheel with locking sleeve, and a R.H./L.H. angled torch head sleeve, all mounted on a shortened, approximately one foot, shaft. The mini-burner configuration can accommodate the mini-burner torch size. In a still further examples, the tool system provided by the present invention burns ninety degree and bevels I.D. and O.D. on a radius. It also performs as a corner burner, burning a radius in a corner or under obstacles. As a track burner, it will burn a straight line at ninety degree or bevel, up to six feet long or as far as the shaft will permit. The tool system can also be used as trammel points or as a protractor. It can also be used as a mini-burner with application of a shorter shaft, still providing the ability to burn ninety degree and bevels. Thus, these examples of the present invention provide at least four burning tools, a mini-burner, a set of trammel points, and a protractor all in one tool system.

In the foregoing, the term ninety-degree as used in practice encompasses various degrees of tolerance and is to be applied as a term representing a substantially straight cut. The terms “burn”, “burner”, and “burning” are typically used in the subject art to describe the apparatus or act of cutting, marking, or depositing on, substances such as metal by the use of a heat source, such as a flame torch or electrical arc. It can be appreciated that the term “torch” may apply to heat sources such as a flame torch or arc.

The foregoing is provided for illustrative purposes only, and is not intended to describe all possible aspects of the present invention. Those of ordinary skill in the pertinent arts will appreciate that minor changes to the description, and various other modifications, omissions and additions can be made without departing from either the spirit or scope of the invention as claimed.

1. A multipurpose plate burner system comprising:
a shaft, whereby a beam is formed;
at least one sleeve movably attached to said shaft, said at least one sleeve having a receiving channel disposed offset from said shaft;
at least one object disposed in said receiving channel, whereby at least one of said at least one object is operable to position contact with a workpiece; and
a torch head receptacle attached to said shaft;
wherein said at least one object disposed in said receiving channel is selected from the group comprising:
a pivot, a pivot arm having an offset pivot point, a leveling wheel, a roller bearing leveler, a trammel point, a soapstone holder, a torch nozzle holder, a table support, a torch saddle, and a flat bottomed pin; and
wherein said torch head receptacle is selected from the group comprising:
a torch nozzle receiving orifice integrated on an end of said shaft, and a torch nozzle holder affixed to a sleeve movably attached to said shaft; and
wherein said torch head receptacle is operable to position a fixed distance from the workpiece.

2. The multipurpose plate burner system of claim 1 wherein said shaft is comprised of one or more beam sections further comprising means for fitting said beam sections together.

3. The multipurpose plate burner system of claim 1 wherein at least one of said at least one sleeve comprises:
a first channel for receiving the beam of said shaft; and
a second channel disposed offset from said first channel for receiving at least one of said at least one object.

4. The multipurpose plate burner system of claim 1 wherein at least one of said at least one sleeve comprises:
a first channel for receiving the beam of said shaft;
a first locking means for affixing the sleeve to a position on said shaft; and
a second channel disposed offset from said first channel for receiving at least one of said at least one object.

5. The multipurpose plate burner system of claim 4 wherein said at least one of said at least one sleeve further comprises:
a second locking means for affixing said at least one of said at least one object to the sleeve.

6. The multipurpose plate burner system of claim 4 wherein said second channel of said at least one of said at least one sleeve comprises a substantially circular opening, whereby an object inserted there through may freely rotate therein.

7. The multipurpose plate burner system of claim 4 wherein said second channel of said at least one of said at least one sleeve is disposed substantially perpendicular to said first channel.

8. The multipurpose plate burner system of claim 4 wherein said at least one of said at least one sleeve further comprises:
a third channel, for receiving at least one of said at least one object, disposed offset from said first channel and opposite said second channel, said third channel having an axial orientation similar to the axial orientation of said second channel; and
a third locking means for affixing said at least one of said at least one object to said at least one of said at least one sleeve.

9. The multipurpose plate burner system of claim 8 wherein the axial orientation of said second channel of said at least one of said at least one sleeve and the axial orientation of said third channel of said at least one of said at least one sleeve are approximately fifty-five degrees relative to the axial direction of said first channel of said at least one of said at least one sleeve.

10. The multipurpose plate burner system of claim 1 wherein said torch nozzle holder comprises:
a first attachment arm, having a first end;
a torch head arm, having a first end, disposed adjacent and parallel to said first attachment arm, said first end of said first attachment arm connected to said first end of the torch head arm;
a second attachment arm, having a first end, disposed adjacent and parallel to said torch head arm, said first end of said torch head arm connected to said first end of the second attachment arm; and
a torch head receptacle disposed on a second end of said torch head arm, said torch head receptacle having a torch receiving orifice positioned perpendicular to the length of said torch head arm;
wherein said first attachment arm and said torch head arm and said second attachment arm are coplanar with respect to said perpendicularly positioned torch receiving orifice; and
wherein the length of said first attachment arm is less than the length of said second attachment arm.

11. A multipurpose plate burner system comprising:
a means for positioning a burning apparatus over a workpiece;
a means for remotely guiding said burning apparatus;
a first means for pivoting said positioning means about a first axis of rotation;
a second means for pivoting said positioning means about a second axis of rotation; and
a means for stabilizing said burning apparatus over the workpiece.

12. The multipurpose plate burner system of claim 11 wherein said means for remotely guiding comprises a shaft.

13. The multipurpose plate burner system of claim 12 wherein said shaft is comprised of one or more beam sections further comprising means for fitting said beam sections together.

14. The multipurpose plate burner system of claim 11 wherein said means for positioning comprises at least one sleeve movably attached to said remote guiding means, said at least one sleeve having a receiving channel disposed offset from said remote guiding means; and at least one object disposed in said receiving channel, whereby said at least one object is operable to position a location of contact with the workpiece.

15. The multipurpose plate burner system of claim 14 wherein said first means for pivoting comprises: one of said at least one sleeve wherein said receiving channel comprises a substantially circular opening, whereby an object inserted there through may freely rotate therein and wherein said object is selected from the group comprising a pivot, and a pivot arm.

16. The multipurpose plate burner system of claim 14 wherein said second means for pivoting comprises: a pivot arm disposed in said receiving channel of one of said at least one sleeve; and a pivot attached to said pivot arm.

17. The multipurpose plate burner system of claim 11 wherein said second means for pivoting comprises: a pivot arm; and a pivot disposed on said pivot arm, said pivot arm disposed in said first means for pivoting.

18. The multipurpose plate burner system of claim 11 wherein said means for stabilizing said burning apparatus comprises at least one sleeve movably attached to said remote guiding means, said at least one sleeve having a receiving channel disposed offset from said remote guiding means; and at least one object disposed in said receiving channel, whereby said at least one object is operable to position a location of contact with the workpiece.

19. The multipurpose plate burner system of claim 11 wherein said means for stabilizing said burning apparatus comprises at least one sleeve movably attached to said remote guiding means, said at least one sleeve further comprising a location of contact with the burning apparatus.

20. A multipurpose plate burner system comprising:
a shaft for deploying a burning apparatus over a workpiece;
a support movably attached to said shaft, said support providing a selected distance between said shaft and the workpiece; and
a torch head receptacle attached to said shaft, said torch head receptacle providing a selected distance between the burning apparatus and the workpiece; and
wherein said support is selected from the group of supports comprising fixed supports, pivotal supports, and multiple pivotal supports.
